(19) United States
(12) Patent Application Publication
(10) Pub. No.: US 2023/0081887 A1
(43) Pub. Date: Mar. 16, 2023

(54) VEHICLE POSITION ESTIMATION METHOD AND VEHICLE CONTROL SYSTEM

(71) Applicant: TOYOTA JIDOSHA KABUSHIKI KAISHA, Toyota-shi Aichi-ken (JP)

(72) Inventor: Hiroki Furuta, Sunto-gun Shizuoka-ken (JP)

(73) Assignee: TOYOTA JIDOSHA KABUSHIKI KAISHA, Toyota-shi Aichi-ken (JP)

(21) Appl. No.: 17/941,141

(22) Filed: Sep. 9, 2022

(30) Foreign Application Priority Data
Sep. 14, 2021 (JP) 2021-149596

(51) Int. Cl. G01C 21/20; G01B 21/30; G01C 21/16

(52) U.S. Cl. CPC G01C 21/20; G01B 21/30; G01C 21/165

(57) ABSTRACT

A vehicle position estimation method includes: acquiring time-series data of a parameter related to a vertical motion of a wheel while the vehicle is traveling; acquiring the parameter around the vehicle, as a reference parameter, from a parameter map indicating a correspondence relationship between the parameter and a position; estimating a vehicle position based on a comparison between the time-series data of the parameter and time-series data of the reference parameter. Meanwhile, road surface roughness around the vehicle in a lateral direction and a lateral position of the vehicle in a road are recognized by using a recognition sensor installed on the vehicle. When the road surface roughness is less than a threshold, a lateral position component of the estimated vehicle position is replaced with the lateral position recognized by using the recognition sensor.

### CROSS-REFERENCE TO RELATED APPLICATION

The present disclosure claims priority to Japanese Patent Application No. 2021-149596, filed on Sep. 14, 2021, the contents of which application are incorporated herein by reference in there entirety.

### BACKGROUND

### Technical Field

The present disclosure relates to a technique for estimating a vehicle position by utilizing a map.

### Background Art

Patent Literature 1 discloses a road surface displacement map that indicates a correspondence relationship between a road surface displacement (road surface unevenness) and a position. By utilizing such the road surface displacement map, vibration suppression control is performed. More specifically, a road surface displacement at a predetermined position ahead of a vehicle is recognized in advance based on the road surface displacement map. A control amount of an active suspension is calculated in advance according to the road surface displacement recognized in advance. Then, the active suspension is controlled at a timing when a wheel passes the predetermined position, and thus the vibration of the vehicle is effectively suppressed.

Patent Literature 2 discloses a reference map that indicates a correspondence relationship between a vertical motion of a wheel and a position. By utilizing such the reference map, vehicle position estimation (localization) is performed. More specifically, during travel of the vehicle, time-series data of the vertical motion of the wheel are detected by using an in-vehicle sensor. A wheel position, that is, the vehicle position is identified by comparing the detected time-series data of the vertical motion of the wheel and the vertical motion indicated by the reference map.

### LIST OF RELATED ART

Patent Literature 1: U.S. Patent Application Publication No. 2018/0154723 (Specification)

Patent Literature 2: U.S. Patent Application Publication No. 2019/0079539 (Specification)

### SUMMARY

There is room for improvement in the vehicle position estimation method such as disclosed in Patent Literature 2. For example, when there is little road surface unevenness in a lateral direction intersecting a direction of travel of a vehicle, an estimation accuracy of a lateral position of the vehicle is liable to be low.

An object of the present disclosure is to provide a technique that can improve accuracy of vehicle position estimation utilizing a map.

A first aspect is directed to a vehicle position estimation method.

The vehicle position estimation method includes:

acquiring time-series data of a parameter related to a vertical motion of a wheel of a vehicle while the vehicle is traveling;

acquiring the parameter around the vehicle, as a reference parameter, from a parameter map indicating a correspondence relationship between the parameter and a position;

estimating a vehicle position of the vehicle based on a comparison between the time-series data of the parameter and time-series data of the reference parameter;

recognizing road surface roughness representing roughness of a road surface around the vehicle in a lateral direction by using a recognition sensor installed on the vehicle;

recognizing a lateral position of the vehicle in a road by using the recognition sensor; and

when the road surface roughness is less than a threshold, replacing a component of the lateral position of the estimated vehicle position with the lateral position recognized by using the recognition sensor.

A second aspect is directed to a vehicle position estimation method.

The vehicle position estimation method includes:

acquiring time-series data of a parameter related to a vertical motion of a wheel of a vehicle while the vehicle is traveling;

acquiring the parameter around the vehicle, as a reference parameter, from a parameter map indicating a correspondence relationship between the parameter and a position; and

estimating a vehicle position of the vehicle based on a comparison between the time-series data of the parameter and time-series data of the reference parameter.

The parameter is calculated based on sensor-based information obtained by a sensor installed on the vehicle.

The acquiring the time-series data of the parameter while the vehicle is traveling includes a first filtering process that applies a first filter to time-series data of the sensor-based information or the parameter.

The parameter in the parameter map also is calculated through the first filtering process using the first filter.

A third aspect is directed to a vehicle position estimation method.

The vehicle position estimation method includes:

acquiring time-series data of a parameter related to a vertical motion of a wheel of a vehicle while the vehicle is traveling;

acquiring the parameter around the vehicle, as a reference parameter, from a parameter map indicating a correspondence relationship between the parameter and a position; and

estimating a vehicle position of the vehicle based on a comparison between the time-series data of the parameter and time-series data of the reference parameter.

The parameter map indicates a correspondence relationship between the parameter, the position, and a vehicle speed.

The acquiring the reference parameter includes acquiring the reference parameter according to a vehicle speed of the vehicle from the parameter map.

A fourth aspect is directed to a vehicle position estimation method.

The vehicle position estimation method includes:

acquiring time-series data of a parameter related to a vertical motion of a wheel of a vehicle while the vehicle is traveling;

acquiring the parameter around the vehicle, as a reference parameter, from a parameter map indicating a correspondence relationship between the parameter and a position; and

estimating a vehicle position of the vehicle based on a comparison between the time-series data of the parameter and time-series data of the reference parameter.

An effective frequency range of the parameter is inversely proportional to a vehicle speed.

The estimating the vehicle position includes making the comparison between the time-series data of the parameter and the time-series data of the reference parameter in a common effective frequency range in which the effective frequency range of the parameter and the effective frequency range of the reference parameter overlap each other.

A fifth aspect is directed to a vehicle control system.

The vehicle control system includes one or more processors.

The one or more processors are configured to execute:

acquiring time-series data of a parameter related to a vertical motion of a wheel of a vehicle while the vehicle is traveling;

acquiring the parameter around the vehicle, as a reference parameter, from a parameter map indicating a correspondence relationship between the parameter and a position;

estimating a vehicle position of the vehicle based on a comparison between the time-series data of the parameter and time-series data of the reference parameter;

recognizing road surface roughness representing roughness of a road surface around the vehicle in a lateral direction by using a recognition sensor installed on the vehicle;

recognizing a lateral position of the vehicle in a road by using the recognition sensor; and

when the road surface roughness is less than a threshold, replacing a component of the lateral position of the estimated vehicle position with the lateral position recognized by using the recognition sensor.

According to the present disclosure, the accuracy of the vehicle position estimation utilizing the map is improved.

### BRIEF DESCRIPTION OF DRAWINGS

FIG. 1 is a schematic diagram showing a configuration example of a vehicle according to an embodiment;

FIG. 2 is a conceptual diagram showing a configuration example of a suspension according to an embodiment;

FIG. 3 is a flow chart showing an example of an unsprung displacement calculation process according to an embodiment;

FIG. 4 is a block diagram showing a configuration example of a vehicle control system according to an embodiment;

FIG. 5 is a block diagram showing an example of driving environment information according to an embodiment;

FIG. 6 is a block diagram showing a configuration example of a map management system according to an embodiment;

FIG. 7 is a conceptual diagram for explaining an unsprung displacement map according to an embodiment;

FIG. 8 is a conceptual diagram showing an example of an unsprung displacement map according to an embodiment;

FIG. 9 is a conceptual diagram for explaining a relationship between a result of sampling of a vertical motion parameter by a sensor and a vehicle speed;

FIG. 10 is a conceptual diagram showing another example of an unsprung displacement map according to an embodiment;

FIG. 11 is a conceptual diagram showing yet another example of an unsprung displacement map according to an embodiment;

FIG. 12 is a conceptual diagram for explaining preview control utilizing an unsprung displacement map according to an embodiment;

FIG. 13 is a flow chart showing preview control utilizing an unsprung displacement map according to an embodiment;

FIG. 14 is a conceptual diagram for explaining an outline of localization utilizing an unsprung displacement map according to an embodiment;

FIG. 15 is a conceptual diagram for explaining an outline of localization utilizing an unsprung displacement map according to an embodiment;

FIG. 16 is a flow chart summarizing localization utilizing an unsprung displacement map according to an embodiment;

FIG. 17 is a flow chart showing an example of Step S200 and Step S300 in localization according to an embodiment;

FIG. 18 is a conceptual diagram for explaining a lateral position correcting process according to an embodiment;

FIG. 19 is a flow chart showing an example of a lateral position correcting process according to an embodiment;

FIG. 20 is a flow chart showing another example of a lateral position correcting process according to an embodiment; and

FIG. 21 is a flow chart showing a map updating process according to an embodiment.

### EMBODIMENTS

Embodiments of the present disclosure will be described below with reference to the attached drawings.

### 1. Suspension and Vertical Motion Parameter

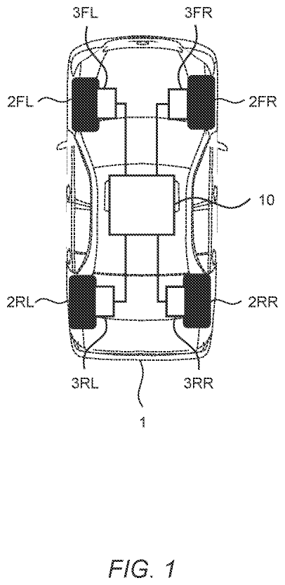

FIG. 1 is a schematic diagram showing a configuration example of a vehicle 1 according to the present embodiment. The vehicle 1 is provided with wheels 2 and suspensions 3. The wheels 2 include a left front wheel 2FL, a right front wheel 2FR, a left rear wheel 2RL, and a right rear wheel 2RR. Suspensions 3FL, 3FR, 3RL, and 3RR are provided for the left front wheel 2FL, the right front wheel 2FR, the left rear wheel 2RL, and the right rear wheel 2RR, respectively. In the following description, each wheel is referred to as a wheel 2 and each suspension is referred to as a suspension 3, if there is no particular need to distinguish from each other.

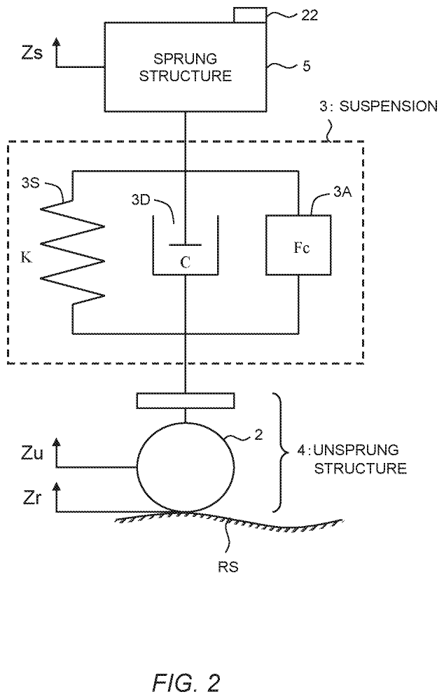

FIG. 2 is a conceptual diagram showing a configuration example of the suspension 3. The suspension 3 is provided so as to connect between an unsprung structure 4 and a sprung structure 5 of the vehicle 1. The unsprung structure 4 includes the wheel 2. The suspension 3 includes a spring 3S, a damper (shock absorber) 3D, and an actuator 3A. The spring 3S, the damper 3D, and the actuator 3A are provided in parallel between the unsprung structure 4 and the sprung structure 5. A spring constant of the spring 3S is K. A damping coefficient of the damper 3D is C. A damping force of the damper 3D may be variable. The actuator 3A applies a control force Fc in a vertical direction between the unsprung structure 4 and the sprung structure 5.

Here, terms are defined. A road surface displacement Zr is a displacement of a road surface RS in the vertical direction. An unsprung displacement Zu is a displacement of the unsprung structure 4 in the vertical direction. A sprung displacement Zs is a displacement of the sprung structure 5 in the vertical direction. An unsprung velocity Zu′ is a velocity of the unsprung structure 4 in the vertical direction. A sprung velocity Zs' is a velocity of the sprung structure 5 in the vertical direction. An unsprung acceleration Zu″ is an acceleration of the unsprung structure 4 in the vertical direction. A sprung acceleration Zs″ is an acceleration of the sprung structure 5 in the vertical direction. It should be noted that a sign of each parameter is positive in a case of upward and is negative in a case of downward.

The wheel 2 moves on the road surface RS. In the following description, a parameter related to a vertical motion of the wheel 2 is referred to as a “vertical motion parameter.” Examples of the vertical motion parameter include the road surface displacement Zr, the unsprung displacement Zu, the unsprung velocity Zu′, the unsprung acceleration Zu″, the sprung displacement Zs, the sprung velocity Zs′, the sprung acceleration Zs″ described above, and the like. It can also be said that the vertical motion parameter is a “road surface displacement related parameter” that is related to the road surface displacement Zr.

As an example, in the following description, a case where the vertical motion parameter is the unsprung displacement Zu will be considered. When generalizing, the “unsprung displacement” in the following description shall be replaced by the “vertical motion parameter.”

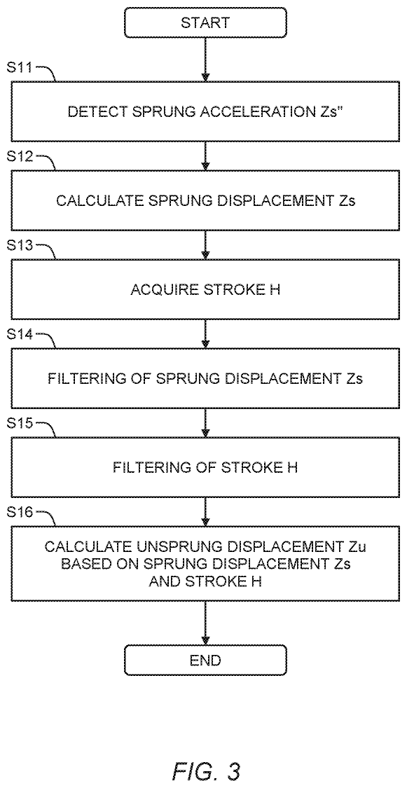

FIG. 3 is a flow chart showing an example of an unsprung displacement calculation process.

In Step S11, the sprung acceleration Zs″ is detected by a sprung acceleration sensor 22 installed on the sprung structure 5. In Step S12, the sprung displacement Zs is calculated by double-integrating the sprung acceleration Zs″.

In Step S13, a stroke H (=Zs−Zu) which is a relative displacement between the sprung structure 5 and the unsprung structure 4 is acquired. For example, the stroke H is detected by a stroke sensor installed on the suspension 3. As another example, the stroke H may be estimated based on the sprung acceleration Zs″ by an observer constructed based on a single-wheel two-degree-of-freedom model.

In Step S14, a filtering process is performed on time-series data of the sprung displacement Zs in order to suppress an influence of a sensor drift and the like. Similarly, in Step S15, a filtering process is performed on time-series data of the stroke H. For example, the filter is a bandpass filter that passes a signal component of a specific frequency range. The specific frequency range may be set to include a sprung resonance frequency of the vehicle 1. For example, the specific frequency range is from 0.3 Hz to 10 Hz.

In Step S16, a difference between the sprung displacement Zs and the stroke H is calculated as the unsprung displacement Zu.

Instead of Steps S14 and S15, a filtering process may be performed on time-series data of the unsprung displacement Zu calculated in Step S16.

As yet another example, the unsprung acceleration Zu″ may be detected by an unsprung acceleration sensor and the unsprung displacement Zu may be calculated from the unsprung acceleration Zu″.

### 2. Vehicle Control System

### 2-1. Configuration Example

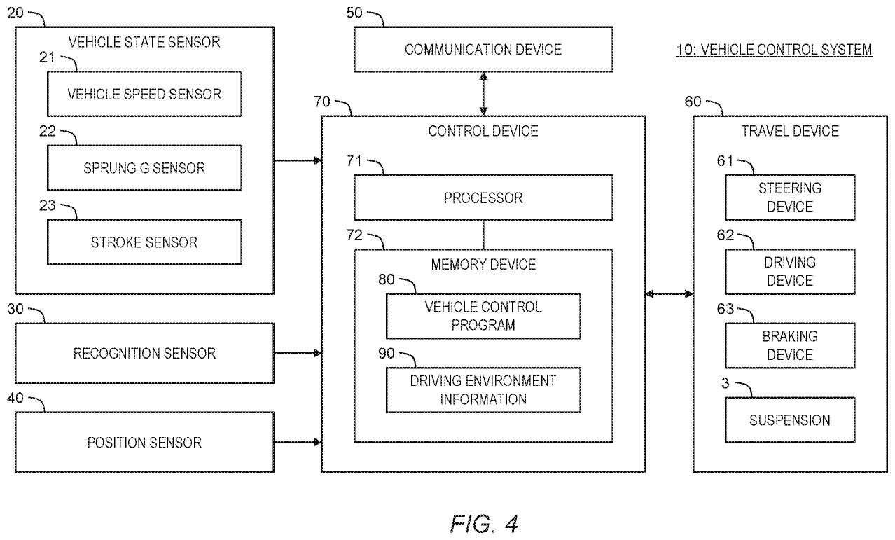

FIG. 4 is a block diagram showing a configuration example of a vehicle control system 10 according to the present embodiment. The vehicle control system 10 is installed on the vehicle 1 and controls the vehicle 1. The vehicle control system 10 includes a vehicle state sensor 20, a recognition sensor 30, a position sensor 40, a communication device 50, a travel device 60, and a control device 70.

The vehicle state sensor 20 detects a state of the vehicle 1. The vehicle state sensor 20 includes a vehicle speed sensor (wheel speed sensor) 21 that detects a vehicle speed V of the vehicle 1, a sprung acceleration sensor 22 that detects the sprung acceleration Zs″, and the like. The vehicle state sensor 20 may include a stroke sensor 23 that detects the stroke H. The vehicle state sensor 20 may include an unsprung acceleration sensor. In addition, the vehicle state sensor 20 includes a lateral acceleration sensor, a yaw rate sensor, a steering angle sensor, and the like.

The recognition sensor 30 recognizes (detects) a situation around the vehicle 1. Examples of the recognition sensor 30 include a camera, a LIDAR (Laser Imaging Detection and Ranging), a radar, and the like.

The position sensor 40 detects a position and an orientation of the vehicle 1. For example, the position sensor 40 includes a GNSS (Global Navigation Satellite System).

The communication device 50 communicates with the outside of the vehicle 1.

The travel device 60 includes a steering device 61, a driving device 62, a braking device 63, and the suspension 3 (see FIG. 2). The steering device 61 steers the wheel 2. For example, the steering device 61 includes an electric power steering (EPS) device. The driving device 62 is a power source for generating a driving force. Examples of the driving device 62 include an engine, an electric motor, an in-wheel motor, and the like. The braking device 63 generates a braking force.

The control device (controller) 70 is a computer that controls the vehicle 1. The control device 70 includes one or more processors 71 (hereinafter simply referred to as a processor 71) and one or more memory devices 72 (hereinafter simply referred to as a memory devices 72). The processor 71 executes a variety of processing. For example, the processor 71 includes a CPU (Central Processing Unit). The memory device 72 stores a variety of information necessary for the processing by the processor 71. Examples of the memory device 72 include a volatile memory, a non-volatile memory, an HDD (Hard Disk Drive), an SSD (Solid State Drive), and the like. The control device 70 may include one or more ECUs (Electronic Control Units).

A vehicle control program 80 is a computer program for controlling the vehicle 1 and is executed by the processor 71. The vehicle control program 80 is stored in the memory device 72. Alternatively, the vehicle control program 80 may be recorded on a non-transitory computer-readable recording medium. Functions of the control device 70 are implemented by the processor 71 executing the vehicle control program 80.

### 2-2. Driving Environment Information

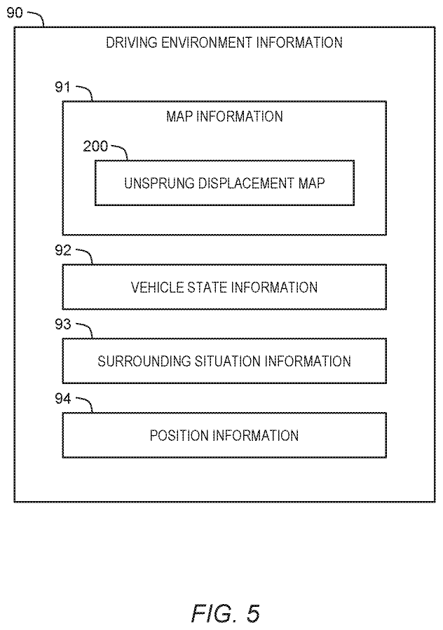

FIG. 5 is a block diagram showing an example of driving environment information 90 indicating a driving environment for the vehicle 1. The driving environment information 90 is stored in the memory device 72. The driving environment information 90 includes map information 91, vehicle state information 92, surrounding situation information 93, and position information 94.

The map information 91 includes a general navigation map. The map information 91 may indicate a lane configuration, a road shape, and the like. The map information 91 may include position information of white lines, traffic lights, signs, landmarks, and the like. The map information 91 is obtained from a map database. It should be noted that the map database may be installed on the vehicle 1 or may be stored in an external management server. In the latter case, the control device 70 communicates with the management server to acquire necessary map information 91.

The map information 91 further includes an “unsprung displacement map 200.” Details of the unsprung displacement map 200 will be described later.

The vehicle state information 92 is information indicating the state of the vehicle 1. The control device 70 acquires the vehicle state information 92 from the vehicle state sensor 20. For example, the vehicle state information 92 includes the vehicle speed V, the sprung acceleration Zs″, the stroke H, the lateral acceleration, the yaw rate, the steering angle, and the like. The vehicle speed V may be calculated from the vehicle position detected by the position sensor 40. The control device 70 may calculate the unsprung displacement Zu by the method shown in FIG. 3. In that case, the vehicle state information 92 also includes the unsprung displacement Zu calculated by the control device 70.

The surrounding situation information 93 is information indicating the situation around the vehicle 1. The control device 70 recognizes the situation around the vehicle 1 by using the recognition sensor 30 to acquire the surrounding situation information 93. For example, the surrounding situation information 93 includes image information captured by the camera. As another example, the surrounding situation information 93 includes point cloud information obtained by the LIDAR.

The surrounding situation information 93 further includes “object information” regarding an object around the vehicle 1. Examples of the object include a pedestrian, a bicycle, another vehicle (e.g., a preceding vehicle, a parked vehicle, and the like), a road structure (e.g., a white line, a curb, a guardrail, a wall, a median strip, a roadside structure, and the like), a sign, a pole, an obstacle, and the like. The object information indicates a relative position and a relative velocity of the object relative to the vehicle 1. For example, analyzing the image information captured by the camera makes it possible to identify an object and calculate the relative position of the object. It is also possible to identify an object and acquire the relative position and the relative velocity of the object based on the point cloud information obtained by the LIDAR.

The position information 94 is information indicating the position and the orientation of the vehicle 1. The control device 70 acquires the position information 94 from a result of detection by the position sensor 40. The control device 70 may acquire high-precision position information 94 by a well-known localization process utilizing the object information and the map information 91.

### 2-3. Vehicle Control

The control device 70 executes vehicle travel control that controls travel of the vehicle 1. The vehicle travel control includes steering control, driving control, and braking control. The control device 70 executes the vehicle travel control by controlling the travel device 60 (i.e., the steering device 61, the driving device 62, and the braking device 63). The control device 70 may execute driving assist control that assists driving of the vehicle 1 based on the driving environment information 90. Examples of the driving assistance control include lane keeping control, collision avoidance control, automated driving control, and the like.

Furthermore, the control device 70 controls the suspension 3. Typically, the control device 70 controls the suspension 3 to perform vibration suppression control that suppresses vibration of the vehicle 1. For example, the control device 70 controls the actuator 3A to generate the control force Fc in the vertical direction between the unsprung structure 4 and the sprung structure 5 (see FIG. 2). As another example, the control device 70 may variably control the damping force of the damper 3D. The vibration suppression control includes “preview control” which will be described later.

### 3. Map Management System

### 3-1. Configuration Example

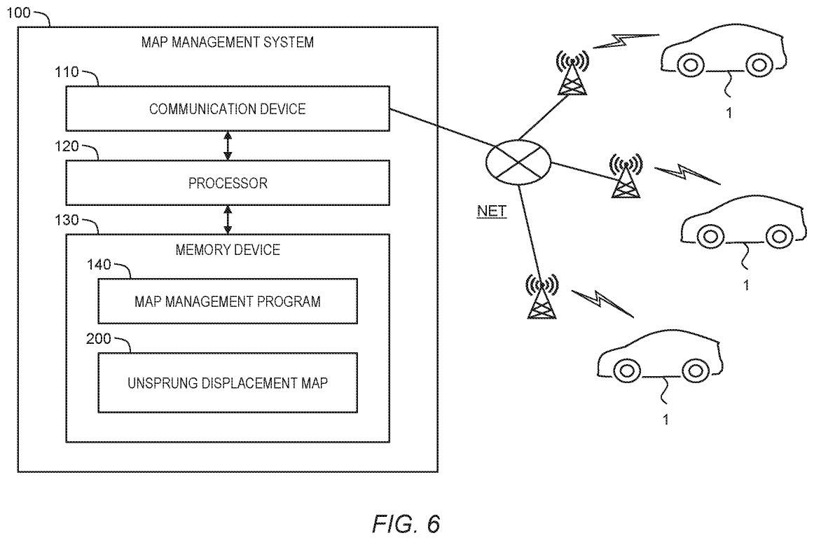

FIG. 6 is a block diagram showing a configuration example of a map management system 100 according to the present embodiment. The map management system 100 is a computer that manages a variety of map information. Managing the map information includes generating, updating, providing, distributing the map information, and the like. Typically, the map management system 100 is a management server on cloud. The map management system 100 may be a distributed system in which a plurality of servers perform distributed processing.

The map management system 100 includes a communication device 110. The communication device 110 is connected to a communication network NET. For example, the communication device 110 communicates with a lot of vehicles 1 via the communication network NET.

The map management system 100 further includes one or more processors 120 (hereinafter simply referred to as a processor 120) and one or more memory devices 130 (hereinafter simply referred to as a memory device 130). The processor 120 executes a variety of information processing. For example, the processor 120 includes a CPU. The memory device 130 stores a variety of map information. In addition, the memory device 130 stores a variety of information necessary for the processing by the processor 120. Examples of the memory device 130 include a volatile memory, a non-volatile memory, an HDD, an SSD, and the like.

A map management program 140 is a computer program for the map management and is executed by the processor 120. The map management program 140 is stored in the memory device 130. Alternatively, the map management program 140 may be recorded on a non-transitory computer-readable recording medium. Functions of the map management system 100 are implemented by the processor 120 executing the map management program 140.

The processor 120 communicates with the vehicle control system 10 of the vehicle 1 via the communication device 110. The processor 120 collects a variety of information from the vehicle control system 10, and generates and updates the map information based on the collected information. Moreover, the processor 120 distributes the map information to the vehicle control system 10. Furthermore, the processor 120 provides the map information in response to a request from the vehicle control system 10.

### 3-2. Unsprung Displacement Map

One of the map information managed by the map management system 100 is the “unsprung displacement map (vertical motion parameter map) 200.” The unsprung displacement map 200 is a map regarding the unsprung displacement Zu (vertical motion parameter). The unsprung displacement map 200 is stored in the memory device 130.

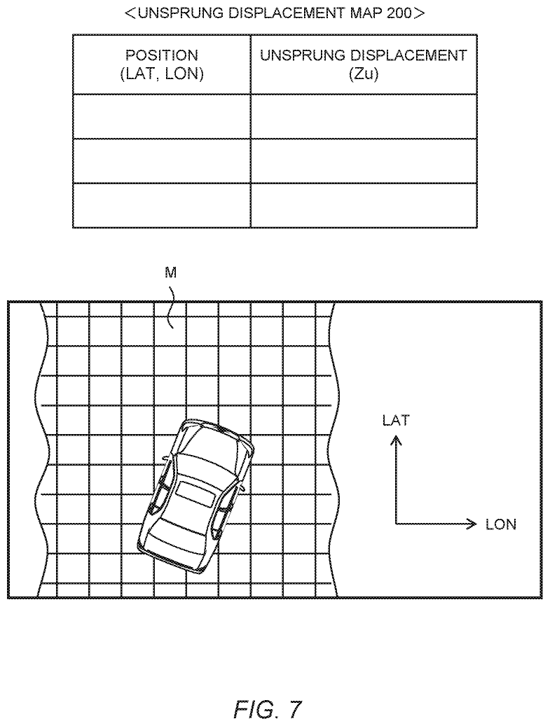

FIG. 7 is a conceptual diagram for explaining the unsprung displacement map 200. An absolute coordinate system in a horizontal plane is defined by, for example, a latitude direction and a longitude direction. A position in the horizontal plane is defined by, for example, a latitude LAT and a longitude LON. The unsprung displacement map 200 indicates a correspondence relationship between the position (LAT, LON) and the unsprung displacement Zu. In other words, the unsprung displacement map 200 expresses the unsprung displacement Zu as a function of the position (LAT, LON).

A road area may be segmented in a mesh pattern on the horizontal plane. That is, the road area may be segmented into a plurality of unit areas M on the horizontal plane. A unit area M is, for example, a square. The square has a side length of, for example, 10 cm. The unsprung displacement map 200 indicates a correspondence relationship between the position of the unit area M and the unsprung displacement Zu. The position of the unit area M may be defined by a representative position (e.g., a center position) of the unit area M, or may be defined by a range (a latitude range and a longitude range) of the unit area M. The unsprung displacement Zu of the unit area M is, for example, an average value of the unsprung displacements Zu acquired within the unit area M. The smaller the unit area M is, the higher a resolution of the unsprung displacement map 200 is.

The processor 120 collects information from a lot of vehicles 1 via the communication device 110. The processor 120 then generates and updates the unsprung displacement map 200 based on the information collected from the lot of vehicles 1. As a method for generating the unsprung displacement map 200, various examples are conceivable as follows.

### 3-2-1. First Example

A position of each wheel 2 is calculated based on the position information 94 described above. More specifically, a relative positional relationship between a reference point of the vehicle position in the vehicle 1 and each wheel 2 is known information. Based on the relative positional relationship and the vehicle position indicated by the position information 94, it is possible to calculate the position of each wheel 2.

The unsprung displacement Zu is calculated by the method as shown in FIG. 3. That is, the sprung displacement Zs and the stroke H are acquired by the use of the vehicle state sensor 20 installed on the vehicle 1. The sprung displacement Zs and the stroke H are referred to as “sensor-based information” for convenience sake. The unsprung displacement Zu is calculated based on the sensor-based information. Here, as described above, in order to suppress the influence of the sensor drift and the like, the filtering process is performed on the time-series data of the sensor-based information or the unsprung displacement Zu.

For example, while the vehicle 1 is traveling, the control device 70 of the vehicle control system 10 calculates the unsprung displacement Zu in real time. However, when calculating the unsprung displacement Zu in real time, it is not possible to use a zero-phase filter due to constraint of a processing time. A filter (on-line filter) that the control device 70 is able to use in real time is hereinafter referred to as a “first filter.” The control device 70 performs a “first filtering process” that applies the first filter to the time-series data of the sensor-based information or the unsprung displacement Zu. The unsprung displacement Zu calculated through the first filtering process is hereinafter referred to as a “first unsprung displacement Zu1.” Regarding the time-series data of the first unsprung displacement Zu1, the first filtering process using the first filter causes a “phase shift.” More specifically, a high-pass filter causes a “phase lead,” and a low-pass filter causes a “phase lag.”

The control device 70 of the vehicle control system 10 associates the position of the wheel 2 with the first unsprung displacement Zu1 of the same timing. Then, the control device 70 transmits a set of the time-series data of the position of the wheel 2 and the time-series data of the first unsprung displacement Zu1 to the map management system 100. Based on the information received from the vehicle control system 10, the processor 120 of the map management system 100 generates the unsprung displacement map 200 indicating a correspondence relationship between the position and the first unsprung displacement Zu1. The unsprung displacement map 200 indicating the correspondence relationship between the position and the first unsprung displacement Zu1 is hereinafter referred to as a “first unsprung displacement map 210.” It can be said that the first unsprung displacement map 210 is the unsprung displacement map 200 generated through the first filtering process using the first filter.

Instead of the vehicle control system 10, the map management system 100 may perform the first filtering process. In this case, the control device 70 of the vehicle control system 10 associates the position of the wheel 2 with the sensor-based information or the unsprung displacement Zu (before the filtering process) of the same timing. Then, the control device 70 transmits a set of the time-series data of the position of the wheel 2 and the time-series data of the sensor-based information or the unsprung displacement Zu (before the filtering process) to the map management system 100. The processor 120 of the map management system 100 performs the first filtering process that applies the first filter to the time-series data of the sensor-based information or the unsprung displacement Zu. The first unsprung displacement Zu1 is calculated through such the first filtering process. The processor 120 generates the first unsprung displacement map 210 based on the position of the wheel 2 and the first unsprung displacement Zu1.

### 3-2-2. Second Example

When the map management system 100 performs the filtering process, a zero-phase filter can be utilized because there is no constraint of the processing time. Utilizing the zero-phase filter makes it possible to prevent the “phase shift.” The filtering process that applies the zero-phase filter to the time-series data of the sensor-based information or the unsprung displacement Zu is hereinafter referred to as a “second filtering process.” The unsprung displacement Zu calculated through the second filtering process is hereinafter referred to as a “second unsprung displacement Zu2.” The unsprung displacement map 200 indicating a correspondence relationship between the position and the second unsprung displacement Zu2 is hereinafter referred to as a “second unsprung displacement map 220.” It can be said that the second unsprung displacement map 220 is the unsprung displacement map 200 generated through the second filtering process using the zero-phase filter.

The control device 70 of the vehicle control system 10 associates the position of the wheel 2 with the sensor-based information or the unsprung displacement Zu (before the filtering process) of the same timing. Then, the control device 70 transmits a set of the time-series data of the position of the wheel 2 and the time-series data of the sensor-based information or the unsprung displacement Zu (before the filtering process) to the map management system 100. The processor 120 of the map management system 100 performs the second filtering process that applies the zero-phase filter (a second filter) to the time-series data of the sensor-based information or the unsprung displacement Zu. The second unsprung displacement Zu2 is calculated through such the second filtering process. The processor 120 generates the second unsprung displacement map 220 based on the position of the wheel 2 and the second unsprung displacement Zu2.

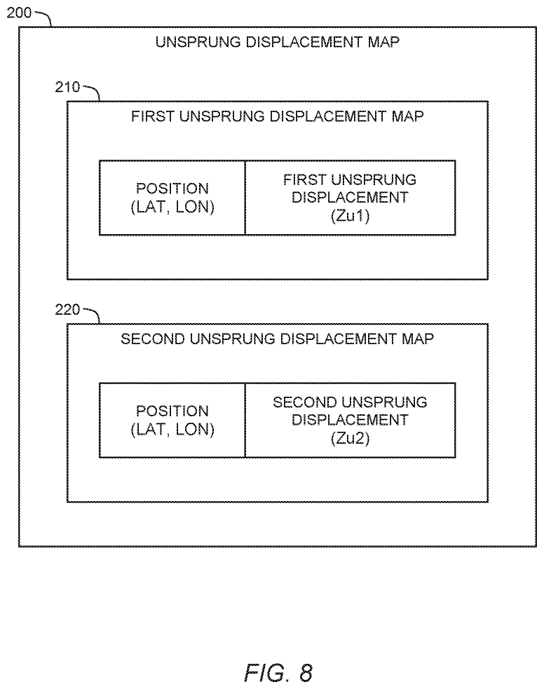

FIG. 8 is a conceptual diagram showing an example of the unsprung displacement map 200. In the example shown in FIG. 8, the unsprung displacement map 200 includes both of the first unsprung displacement map 210 and the second unsprung displacement map 220. In this case, the first unsprung displacement map 210 and the second unsprung displacement map 220 are selectively used depending on the intended use, as will be described later.

As another example, the unsprung displacement map 200 may include only one of the first unsprung displacement map 210 and the second unsprung displacement map 220.

### 3-2-3. Third Example

The unsprung displacement map 200 may indicate a correspondence relationship between the unsprung displacement Zu before the filtering process and the position.

### 3-2-4. Fourth Example

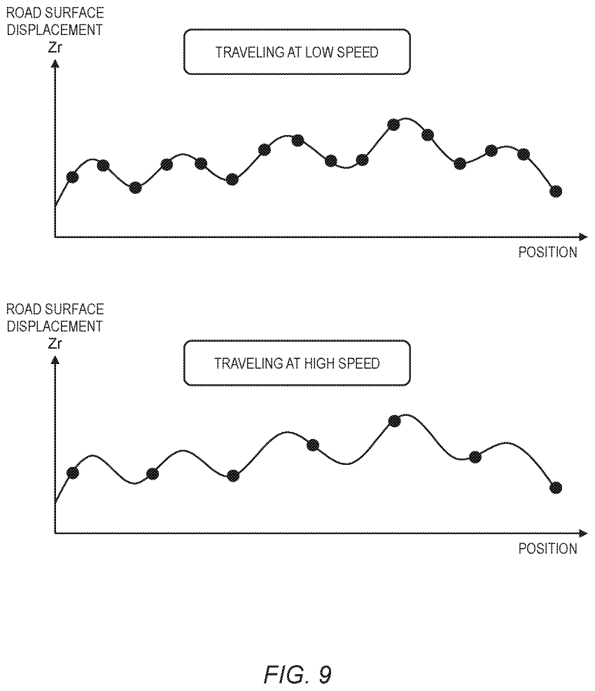

FIG. 9 is a conceptual diagram for explaining a relationship between a result of sampling of the vertical motion parameter by the sensor and the vehicle speed V. A horizontal axis represents the position on a path through which the wheel 2 passes. A vertical axis represents the road surface displacement Zr as an example of the vertical motion parameter. Even when the wheel 2 passes an exact same path, the result of sampling by the sensor varies depending on the vehicle speed V. More specifically, when traveling at a low speed, fine irregularities of the road surface RS are detected (extracted). That is, when traveling at a low speed, short wavelength and high spatial frequency data are detected. On the other hand, when traveling at a high speed, fine irregularities of the road surface RS are not detected (extracted). That is, when traveling at a high speed, long wavelength and low spatial frequency data are detected, short wavelength and high spatial frequency data are hard to be detected. As described above, the vehicle speed V and the detectable spatial frequency are inversely proportional.

In view of the above, in the fourth example, the unsprung displacement map 200 is generated in consideration of the vehicle speed V. More specifically, the control device 70 of the vehicle control system 10 associates the position of the wheel 2 with the vehicle speed V at passing that position, and transmits a set of the position and the vehicle speed V to the map management system 100. The processor 120 of the map management system 100 generates the unsprung displacement map 200 based on the position and the vehicle speed V. That is, the unsprung displacement map 200 indicates a correspondence relationship between the position, the vehicle speed V, and the unsprung displacement Zu.

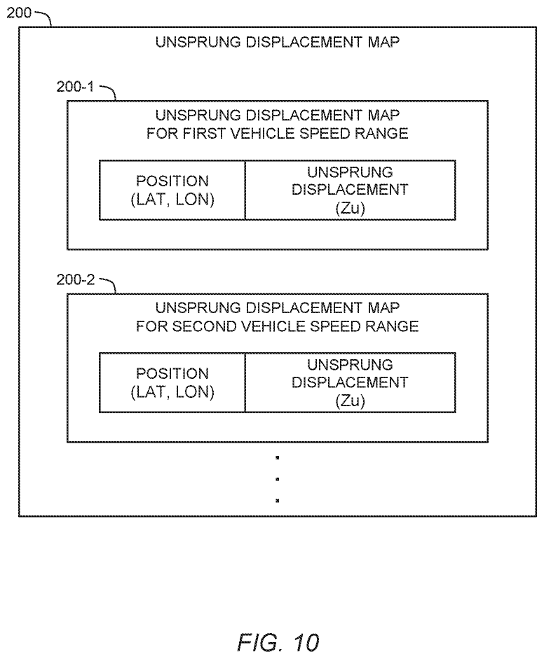

FIG. 10 shows an example of the unsprung displacement map 200 according to the fourth example. In the example shown in FIG. 10, the unsprung displacement map 200 indicates the correspondence relationship between the position and the unsprung displacement Zu for each vehicle speed range. In other words, a different unsprung displacement map 200 is prepared for each vehicle speed range. For example, an unsprung displacement map 200-1 is the unsprung displacement map 200 that is used when the vehicle speed V belongs to a first vehicle speed range. An unsprung displacement map 200-2 is the unsprung displacement map 200 that is used when the vehicle speed V belongs to a second vehicle speed range different from the first vehicle speed range.

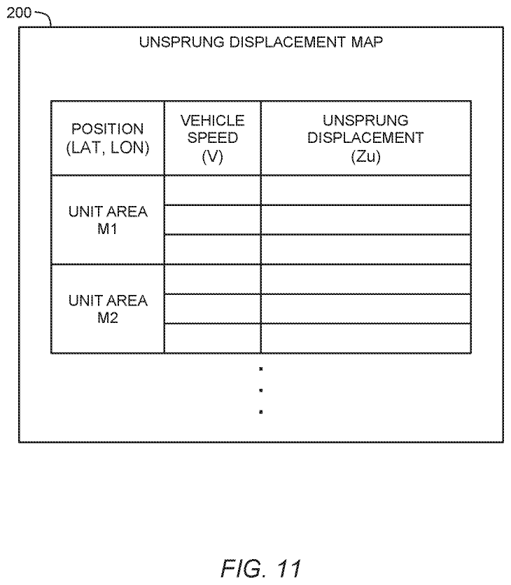

FIG. 11 shows another example of the unsprung displacement map 200 according to the fourth example. In the example shown in FIG. 11, the position is the position of the unit area M (see FIG. 7). The unsprung displacement map 200 indicates the correspondence relationship between the vehicle speed V (or the vehicle speed range) and the unsprung displacement Zu for each position of the unit area M.

### 3-2-5. Fifth Example

A combination of any of the first to third examples and the fourth example described above is also possible. That is, the first unsprung displacement map 210 may indicate a correspondence relationship between the position, the vehicle speed V, and the first unsprung displacement Zu1. Similarly, the second unsprung displacement map 220 may indicate a correspondence relationship between the position, the vehicle speed V, and the second unsprung displacement Zu2.

### 4. Preview Control Utilizing Unsprung Displacement Map

The control device 70 of the vehicle control system 10 communicates with the map management system 100 via the communication device 50. The control device 70 acquires the unsprung displacement map 200 of an area including a current position of the vehicle 1 from the map management system 100. The unsprung displacement map 200 is stored in the memory device 72. Then, based on the unsprung displacement map 200, the control device 70 executes “preview control” which is a kind of the vibration suppression control.

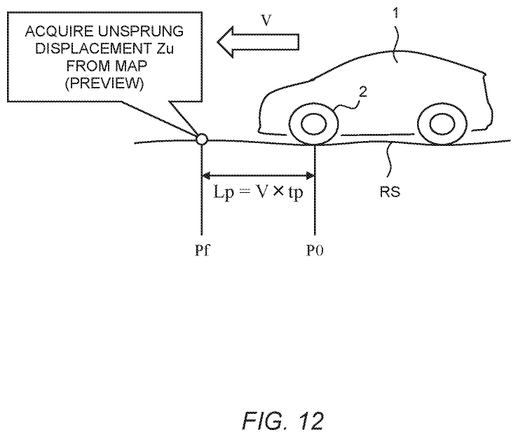

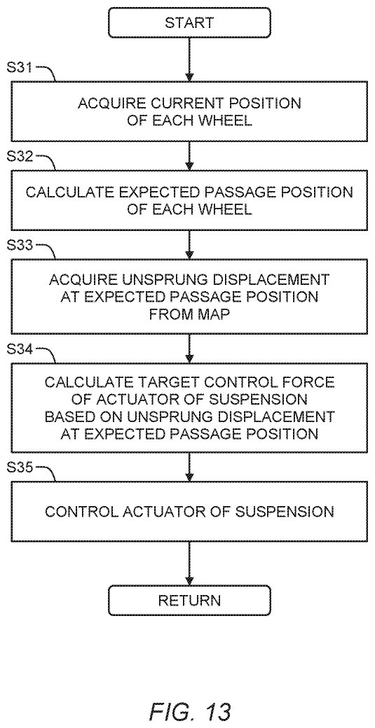

FIG. 12 is a conceptual diagram for explaining the preview control. FIG. 13 is a flow chart showing the preview control. The preview control will be described with reference to FIGS. 12 and 13.

In Step S31, the control device 70 acquires a current position P0 of each wheel 2. The relative positional relationship between the reference point of the vehicle position in the vehicle 1 and each wheel 2 is known information. Based on the relative positional relationship and the vehicle position indicated by the position information 94, it is possible to calculate the position of each wheel 2.

In Step S32, the control device 70 calculates an expected passage position Pf of the wheel 2 after a preview time tp. For example, the preview time tp is set to be equal to or more than a time required for computation processing and communication processing required to actuate the actuator 3A of the suspension 3. The preview time tp may be fixed or may be variable depending on a situation. A preview distance Lp is given by a product of the preview time tp and the vehicle speed V. The expected passage position Pf is a position the preview distance Lp ahead of the current position P0. As a modification example, the control device 70 may calculate an expected travel route based on the vehicle speed V and the steering angle of the wheel 2 and then calculate the expected passage position Pf based on the expected travel route.

In Step S33, the control device 70 reads the unsprung displacement Zu at the expected passage position Pf from the unsprung displacement map 200. In one example, the control device 70 uses the second unsprung displacement map 220 with no “phase shift” (see Section 3-2-2) as a reference map and reads the second unsprung displacement Zu2 at the expected passage position Pf from the second unsprung displacement map 220.

In Step S34, the control device 70 calculates a target control force Fc_t of the actuator 3A of the suspension 3 based on the unsprung displacement Zu (the second unsprung displacement Zu2) at the expected passage position Pf. For example, the target control force Fc_t is calculated as follows.

An equation of motion regarding the sprung structure 5 (see FIG. 2) is expressed by the following Equation (1).

[Equation 1]

m·Zs″=C(Zu′−Zs)+K(Zu−Zs)−Fc (1)

In Equation (1), m is a mass of the sprung structure 5, C is the damping coefficient of the damper 3D, K is the spring constant of the spring 3S, Fc is the control force Fc in the vertical direction generated by the actuator 3A. When vibration of the sprung structure 5 is completely canceled by the control force Fc (i.e., Zs″=0, Zs'=0, Zs=0), the control force Fc is expressed by the following Equation (2).

[Equation 2]

Fc=C·Zu′+K·Zu (2)

The control force Fc that at least brings about the vibration suppression effect is expressed by the following Equation (3).

[Equation 3]

Fc=α·C·Zu′+β·K·Zu (3)

In Equation (3), a gain α is greater than 0 and equal to or less than 1, and a gain β also is greater than 0 and equal to or less than 1. When the derivative term in Equation (3) is omitted, the control force Fc that at least brings about the vibration suppression effect is expressed by the following Equation (4).

[Equation 4]

Fc=β·K·Zu (4)

The control device 70 calculates the target control force Fc_t in accordance with the above-described Equation (3) or Equation (4). That is, the control device 70 calculates the target control force Fc_t by substituting the unsprung displacement Zu (second unsprung displacement Zu2) at the expected passage position Pf into Equation (3) or Equation (4).

In Step S35, the control device 70 controls the actuator 3A to generate the target control force Fc_t at a timing when the wheel 2 passes the expected passage position Pf. The timing at which the wheel 2 passes the expected passage position Pf can be recognized from the preview time tp.

The preview control utilizing the unsprung displacement map 200 described above makes it possible to effectively suppress the vibration of the vehicle 1 (the sprung structure 5). In particular, by using the second unsprung displacement Zu2 with no phase shift acquired from the second unsprung displacement map 220, it is possible to accurately generate the target control force Fc_t required for suppressing the vibration at the expected passage position Pf. That is, the accuracy of the preview control is improved.

### 5. Localization Utilizing Unsprung Displacement Map

Next, localization utilizing the unsprung displacement map 200 will be described. The localization is a process that the control device 70 of the vehicle control system 10 estimates the vehicle position of the vehicle 1.

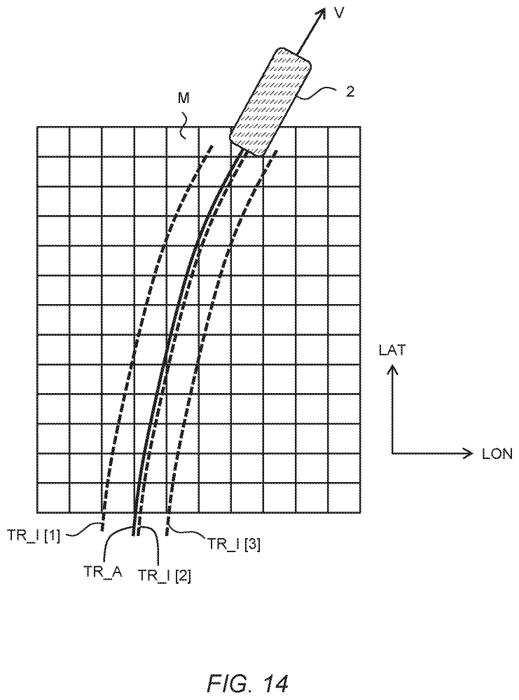

FIG. 14 is a conceptual diagram for explaining an outline of the localization utilizing the unsprung displacement map 200.

An actual trajectory TR_A is a trajectory through which the wheel 2 has actually passed. The unsprung displacement Zu on the actual trajectory TR_A is hereinafter referred to as a “detected unsprung displacement Zu_d” or a “detected parameter.” Time-series data of the detected unsprung displacement Zu_d along the actual trajectory TR_A are acquired in real time by the method shown in FIG. 3.

On the other hand, an imaginary (virtual) trajectory TR_I is a trajectory that is virtually set in the vicinity of the vehicle 1. The imaginary trajectory TR_I is set based on a rough vehicle position and a direction of travel that are acquired from the position information 94. Here, a plurality of imaginary trajectories TR_I are set. As an example, three kinds of imaginary trajectories TR_I[1] to TR_I[3] are illustrated in FIG. 14. The unsprung displacement Zu on the imaginary trajectory TR_I is hereinafter referred to as a “reference unsprung displacement Zu_ref” or a “reference parameter.” Time series data of the reference unsprung displacement Zu_ref along each imaginary trajectory TR_I are obtained from the unsprung displacement map 200 (i.e., the reference map).

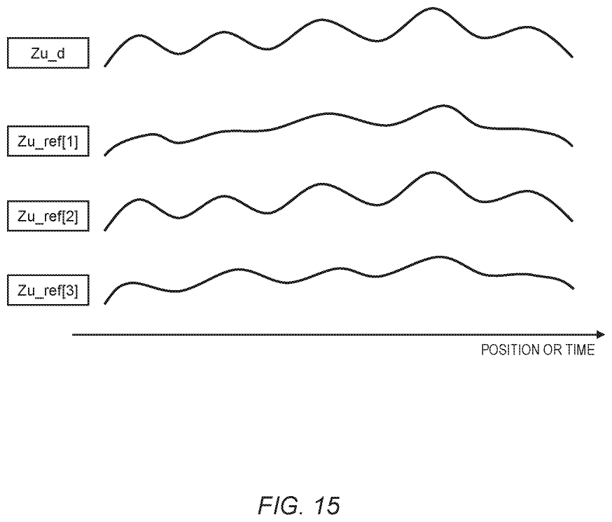

FIG. 15 shows an example of the time-series data of the detected unsprung displacement Zu_d and the time-series data of a plurality of reference unsprung displacements Zu_ref. A horizontal axis represents position or time. Conversion between a space domain and a time domain is possible by using the vehicle speed V.

For example, a comparison is made between the time-series data of the detected unsprung displacement Zu_d and the time-series data of the plurality of reference unsprung displacements Zu_ref. Then, one imaginary trajectory TR_I that yields a highest correlation between the time-series data of the detected unsprung displacement Zu_d and the time-series data of the reference unsprung displacement Zu_ref is selected. In the example shown in FIG. 15, the correlation between the time-series data of the detected unsprung displacement Zu_d and the time-series data of the reference unsprung displacement Zu_ref[2] is the highest, and thus the imaginary trajectory TR_I[2] is selected. The position of the selected imaginary trajectory TR_I[2] is estimated as the position of the wheel 2, and the vehicle position is calculated from the position of the wheel 2. The relative positional relationship between the reference point of the vehicle position in the vehicle 1 and each wheel 2 is known information.

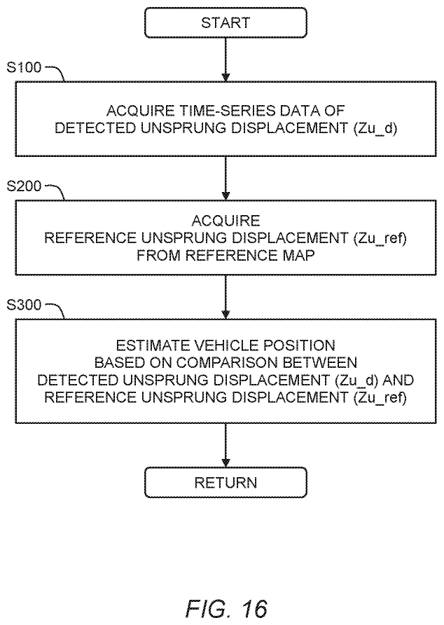

FIG. 16 is a flow chart that summarizes the localization utilizing the unsprung displacement map 200.

In Step S100, the control device 70 acquires the time-series data of the detected unsprung displacement Zu_d in real time by the method shown in FIG. 3.

In Step S200, the control device 70 acquires the reference unsprung displacement Zu_ref around the vehicle 1 from the unsprung displacement map 200 (i.e., the reference map).

In Step S300, the control device 70 estimates the vehicle position based on a comparison between the time-series data of the detected unsprung displacement Zu_d and the time-series data of the reference unsprung displacement Zu_ref.

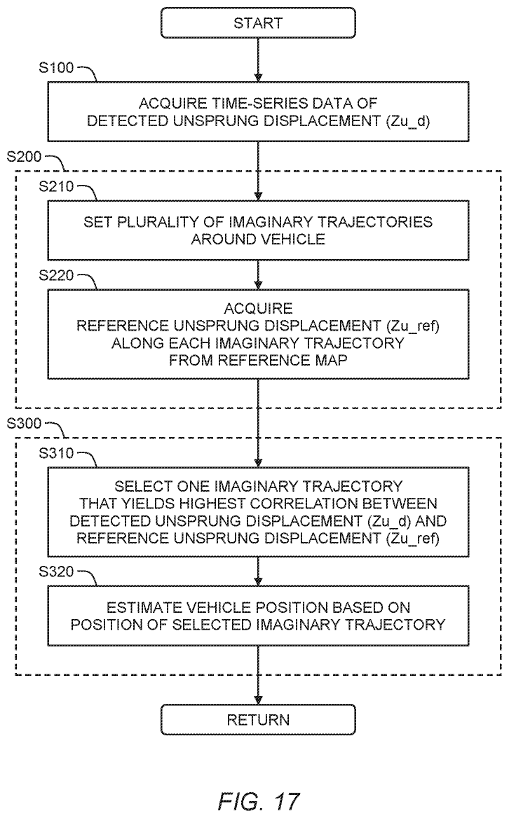

FIG. 17 is a flow chart showing an example of Step S200 and Step S300.

In Step S210, the control device 70 sets a plurality of imaginary trajectories TR_I of the wheel 2, around the vehicle 1. The rough position and the direction of travel of the vehicle 1 are acquired from the position information 94. The control device 70 sets a plurality of imaginary trajectories TR_I of the wheel 2 based on the rough position and the direction of travel of the vehicle 1.

In Step S220, the control device 70 acquires the time-series data of the reference unsprung displacement Zu_ref along each imaginary trajectory TR_I from the unsprung displacement map 200 (i.e., the reference map).

In Step S310, the control device 70 makes a comparison between the time-series data of the detected unsprung displacement Zu_d and the time-series data of the plurality of reference unsprung displacements Zu_ref. Then, the control device 70 selects, from the plurality of imaginary trajectories TR_I, one imaginary trajectory TR_I that yields a highest correlation between the time-series data of the detected unsprung displacement Zu_d and the time-series data of the reference unsprung displacement Zu_ref

In Step S320, the control device 70 estimates the vehicle position based on the position of the selected one imaginary trajectory TR_I.

The inventor of the present application has studied a method for further improving the accuracy of the localization utilizing the unsprung displacement map 200. Hereinafter, the improvement of the estimation accuracy of the vehicle position will be described from various points of view.

### 5-1. First Example for Improving Estimation Accuracy

As described above, in Step S100, the control device 70 acquires the time-series data of the detected unsprung displacement Zu_d in real time by the method shown in FIG. 3. At this time, it is not possible to use the zero phase filter due to the constraint of the processing time. Therefore, the control device 70 acquires the time-series data of the detected unsprung displacement Zu_d through the first filtering process using the first filter. As a result, the “phase shift” occurs in the time-series data of the detected unsprung displacement Zu_d.

If the second unsprung displacement map 220 (see Section 3-2-2) is used as the reference map in Step S200, the second unsprung displacement Zu2 with no phase shift is read as the reference unsprung displacement Zu_ref. If the second unsprung displacement Zu2 is used as it is in Step S300, the comparison is made between the time-series data of the detected unsprung displacement Zu_d with phase shift and the time-series data of the reference unsprung displacement Zu_ref with no phase shift. This leads to a decrease in the estimation accuracy of the vehicle position.

In view of the above, according to a first example, the control device 70 uses the first unsprung displacement map 210 (see Section 3-2-1) as the reference map in Step S200. The first unsprung displacement Zu1 in the first unsprung displacement map 210 is calculated through the first filtering process using the first filter as in the case of Step S100. Therefore, the time-series data of the detected unsprung displacement Zu_d and the time-series data of the reference unsprung displacement Zu_ref (i.e., the first unsprung displacement Zu1), which are compared with each other in Step S300, are consistent in the phase. It is thus possible to estimate the vehicle position with high accuracy.

### 5-2. Second Example for Improving Estimation Accuracy

In a second example, the second unsprung displacement map 220 (see Section 3-2-2) is used as the reference map in Step S200. However, as described above, when the second unsprung displacement Zu2 is used as it is, the phase mismatch occurs.

Therefore, after reading the second unsprung displacement Zu2 as the reference unsprung displacement Zu_ref from the second unsprung displacement map 220, the control device 70 further applies the first filter to the time-series data of the read reference unsprung displacement Zu_ref. In other words, the control device 70 performs the first filtering process on the time-series data of the reference unsprung displacement Zu_ref (i.e., the second unsprung displacement Zu2) acquired from the reference map. In Step S300, the time-series data of the reference unsprung displacement Zu_ref after the first filtering process are compared with the time-series data of the detected unsprung displacement Zu_d. As a result, both phases match, and it is thus possible to estimate the vehicle position with high accuracy.

As a modification example, the control device 70 may beforehand grasp an amount of the phase shift caused by the first filter, and then correct the position of the reference unsprung displacement Zu_ref (i.e., the second unsprung displacement Zu2) acquired from the reference map by the amount of the phase shift.

### 5-3. Third Example for Improving Estimation Accuracy

When the unsprung displacement map 200 indicates the correspondence relationship between the unsprung displacement Zu before the filtering process and the position (see Section 3-2-3), the same processing as in the case of the second example described above is performed. The control device 70 reads the unsprung displacement Zu before the filtering process as the reference unsprung displacement Zu_ref from the unsprung displacement map 200. Then, the control device 70 performs the first filtering process on the time-series data of the read reference unsprung displacement Zu_ref, or corrects the position by the amount of the phase shift.

### 5-4. Fourth Example for Improving Estimation Accuracy

As shown in FIG. 9, even when the wheel 2 passes an exact same path, the result of sampling by the sensor varies depending on the vehicle speed V. In other words, a frequency range of the unsprung displacement Zu varies depending on the vehicle speed V. If the vehicle speed V at the time of generating the unsprung displacement map 200 and the vehicle speed V at the time of Step S100 differ greatly, the detected unsprung displacement Zu_d and the reference unsprung displacement Zu_ref of different frequency ranges are compared in Step S300. This leads to a decrease in the estimation accuracy of the vehicle position.

In view of the above, in a fourth example, the localization is performed in consideration of the vehicle speed V. For that purpose, the unsprung displacement map 200 generated in consideration of the vehicle speed V (see Sections 3-2-4, FIGS. 10 and 11) is used as the reference map. The reference map indicates the correspondence relationship between the position, the vehicle speed V, and the unsprung displacement Zu. In Step S200, the control device 70 acquires the reference unsprung displacement Zu_ref according to the current vehicle speed V from the reference map. As a result, effective frequency ranges of the detected unsprung displacement Zu_d and the reference unsprung displacement Zu_ref match, and thus the estimation accuracy of the vehicle position is improved.

In the example shown in FIG. 10, a different unsprung displacement map 200 is prepared for each vehicle speed range. In Step S200, the control device 70 selects, as the reference map, the unsprung displacement map 200 for a vehicle speed range to which the current vehicle speed V belongs. Then, the control device 70 acquires the reference unsprung displacement Zu_ref from the selected reference map.

In the example shown in FIG. 11, the unsprung displacement map 200 indicates the correspondence relationship between the vehicle speed V (or the vehicle speed range) and the unsprung displacement Zu for each position of the unit area M. In Step S200, the control device 70 selects an entry associated with an unit area M to which the imaginary trajectory TR_I belongs. Then, the control device 70 acquires the reference unsprung displacement Zu_ref corresponding to the current vehicle speed V from the selected entry.

### 5-5. Fifth Example for Improving Estimation Accuracy

In a fifth example, the effective frequency range of the unsprung displacement Zu, which depends on the vehicle speed V, is taken into consideration. As described above, when traveling at a low speed, short wavelength and high spatial frequency data are detected. On the other hand, when traveling at a high speed, long wavelength and low spatial frequency data are detected. That is to say, the vehicle speed V and the detectable spatial frequency are inversely proportional.

As an example, let us consider a case where the unsprung displacement map 200 is generated based on data obtained when the vehicle speed V is 50 kph while the current vehicle speed V is 100 kph. It is assumed that the filter setting is 0.3 to 10 Hz. From a viewpoint of the current vehicle speed V (=100 kph), the effective frequency range of the reference unsprung displacement Zu_ref acquired from the unsprung displacement map 200 is 0.6 to 20 Hz. In other words, data on the lower frequency side is missing. In view of the above, a common effective frequency range (=0.6 to 10 Hz) in which the effective frequency range (=0.3 to 10 Hz) of the detected unsprung displacement Zu_d and the effective frequency range (=0.6 to 20 Hz) of the reference unsprung displacement Zu_ref overlap each other is extracted. Then, the comparison between the time-series data of the detected unsprung displacement Zu_d and the time-series data of the reference unsprung displacement Zu_ref is made in the common effective frequency range (=0.6 to 10 Hz). As a result, the influence of the difference in the vehicle speed V is suppressed.

As an inverse example, let us consider a case where the unsprung displacement map 200 is generated based on data obtained when the vehicle speed V is 100 kph while the current vehicle speed V is 50 kph. From a viewpoint of the current vehicle speed V (=50 kph), the effective frequency range of the reference unsprung displacement Zu_ref acquired from the unsprung displacement map 200 is 0.15 to 5 Hz. In other words, data on the higher frequency side is missing. In view of the above, a common effective frequency range (=0.3 to 5 Hz) in which the effective frequency range (=0.3 to 10 Hz) of the detected unsprung displacement Zu_d and the effective frequency range (=0.15 to 5 Hz) of the reference unsprung displacement Zu_ref overlap each other is extracted. Then, the comparison between the time-series data of the detected unsprung displacement Zu_d and the time-series data of the reference unsprung displacement Zu_ref is made in the common effective frequency range (=0.3 to 5 Hz). As a result, the influence of the difference in the vehicle speed V is suppressed.

As described above, the effective frequency range of the unsprung displacement Zu is inversely proportional to the vehicle speed V. The effective frequency range becomes higher as the vehicle speed V becomes lower, and the effective frequency range becomes lower as the vehicle speed V becomes higher. In Step S300, the control device 70 recognizes the effective frequency range of the detected unsprung displacement Zu_d based on the current vehicle speed V. The control device 70 also recognizes the effective frequency range of the reference unsprung displacement Zu_ref acquired from the unsprung displacement map 200. The effective frequency range of the reference unsprung displacement Zu_ref is recognized based on the vehicle speed V at the time when the unsprung displacement Zu registered in the unsprung displacement map 200 is calculated. The vehicle speed V at the time when the unsprung displacement Zu registered in the unsprung displacement map 200 is calculated may be registered in the unsprung displacement map 200. Furthermore, the control device 70 recognizes a common effective frequency range in which the effective frequency range of the detected unsprung displacement Zu_d and the effective frequency range of the reference unsprung displacement Zu_ref overlap each other. Then, the control device 70 makes a comparison between the time-series data of the detected unsprung displacement Zu_d and the time-series data of the reference unsprung displacement Zu_ref in the common effective frequency range. For example, the control device 70 uses a band-pass filter or the like to extract components of the detected unsprung displacement Zu_d and the reference unsprung displacement Zu_ref of the common effective frequency range and compare them.

### 5-6. Sixth Example for Improving Estimation Accuracy

When there is little road surface unevenness in a lateral direction intersecting a direction of travel of the vehicle 1, the estimation accuracy of a lateral position of the vehicle 1 is liable to be low. In view of the above, in a sixth example, a “lateral position correcting process” that corrects the lateral position of the vehicle 1 is performed as necessary.

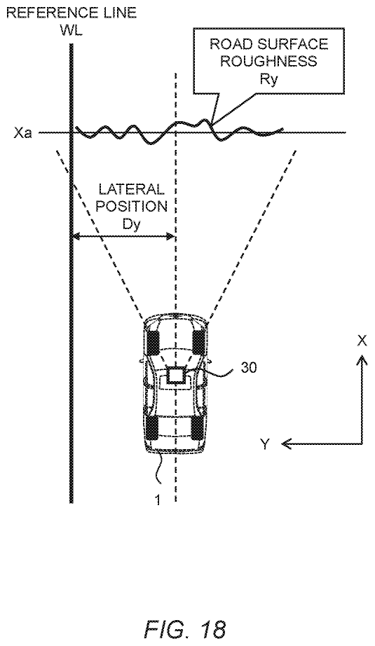

FIG. 18 is a conceptual diagram for explaining the lateral position correcting process. An XY coordinate system is a vehicle coordinate system fixed to the vehicle 1. The X-direction represents the direction of travel of the vehicle 1, and the Y-direction represents the lateral direction of the vehicle 1. The X-direction and the Y-directions intersect with each other. The direction of travel of the vehicle 1 is obtained from the position information 94.

A “lateral position Dy” is the Y-direction position of the vehicle 1 in a road. A reference line WL that extends along the road is a reference for the lateral position Dy. Examples of the reference line WL include a white line and a curb. The lateral position Dy is the Y-direction position of the vehicle 1 with respect to the reference line WL. That is, the lateral position Dy corresponds to the Y-direction distance between the reference line WL and the vehicle position (or the position of the wheel 2). It should be noted that since the relative positional relationship between the reference point of the vehicle position and each wheel 2 is known, the vehicle position and the position of the wheel 2 are treated as equivalent.

The lateral position Dy is acquired from the surrounding situation information 93 (see FIG. 5) that indicates the result of recognition by the recognition sensor 30 (e.g., camera, LIDAR) installed on the vehicle 1. More specifically, the reference line WL such as the white line and the curb is recognized by the use of the recognition sensor 30, and a relative position of the reference line WL with respect to the vehicle 1 is calculated. For example, analyzing the image information captured by the camera makes it possible to identify the reference line WL and to calculate the relative position of the reference line WL. It is also possible to identify the curb and to acquire the relative positions of the curb based on the point cloud information acquired by the LIDAR. Then, the lateral position Dy is acquired from the relative position of the reference line WL with respect to the vehicle 1.

“Road surface roughness Ry” represents roughness of the road surface RS around the vehicle 1 in the Y-direction. That is, the road surface roughness Ry represents a variation of the road surface displacements Zr around the vehicle 1 in the Y-direction. In other words, the road surface roughness Ry represents how much the road surface displacement Zr varies in the Y-direction. The road surface roughness Ry is also acquired from the surrounding situation information 93 indicating the result of recognition by the recognition sensor 30 installed on the vehicle 1. For example, the road surface displacements Zr of the road surface RS around the vehicle 1 are measured by the LIDAR. Based on a variance of the measured road surface displacements Zr in the Y-direction, the road surface roughness Ry is calculated. The road surface roughness Ry increases as the variance of the road surface displacements Zr in the Y-direction increases. For example, as shown in FIG. 18, the road surface roughness Ry at a position Xa ahead of the vehicle 1 is calculated.

For convenience sake, the vehicle position estimated by the above-described Steps S100 to S300 is referred to as a “provisional vehicle position.” A “provisional lateral position” is a component corresponding to the lateral position Dy in the provisional vehicle position. That is, the provisional lateral position is the Y-direction position of the provisional vehicle position with respect to the reference line WL. The provisional lateral position corresponds to a Y-direction distance between the provisional vehicle position and the reference line WL. The position (LAT, LON) of the reference line WL in the absolute coordinate system is registered in the map information 91 (see FIG. 5). It is possible to calculate the provisional lateral position based on the map information 91 and the provisional vehicle position.

When there is little road surface unevenness in the Y-direction is small, that is, when the road surface roughness Ry is small, the estimation accuracy of the provisional lateral position of the provisional vehicle position estimated by Steps S100 to S300 is liable to be low. On the other hand, the accuracy of the lateral position Dy recognized by using the recognition sensor 30 is comparatively high. In view of the above, when the road surface roughness Ry is less than a predetermined threshold Ry_th, the provisional lateral position of the provisional vehicle position is replaced with the lateral position Dy recognized by using the recognition sensor 30. That is, the estimated vehicle position is corrected based on the lateral position Dy and a final estimated vehicle position is determined. This is the lateral position correcting process. The lateral position correcting process makes it possible to improve the estimation accuracy of the vehicle position even when the road surface roughness Ry is small.

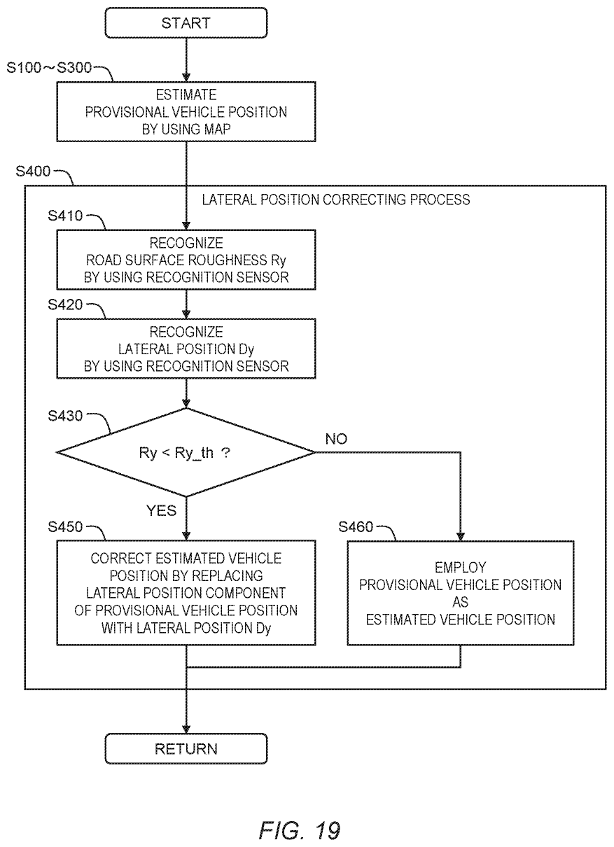

FIG. 19 is a flow chart showing an example of the lateral position correcting process. The control device 70 of the vehicle control system 10 performs the lateral position correcting process (Step S400) following the above-described Steps S100 to S300.

In Step S410, the control device 70 recognizes the road surface roughness Ry by using the recognition sensor 30. In Step S420, the control device 70 recognizes the lateral position Dy by using the recognition sensor 30. In Step S430, the control device 70 compares the road surface roughness Ry and the threshold Ry_th. When the road surface roughness Ry is less than the threshold Ry_th (Step S430; Yes), the control device 70 corrects the estimated vehicle position by replacing the provisional lateral position of the provisional vehicle position with the lateral position Dy (Step S450). On the other hand, when the road surface roughness Ry is equal to or greater than the threshold Ry_th (Step S430; No), the control device 70 employs the provisional vehicle position as it is as the estimated vehicle position (Step S460).

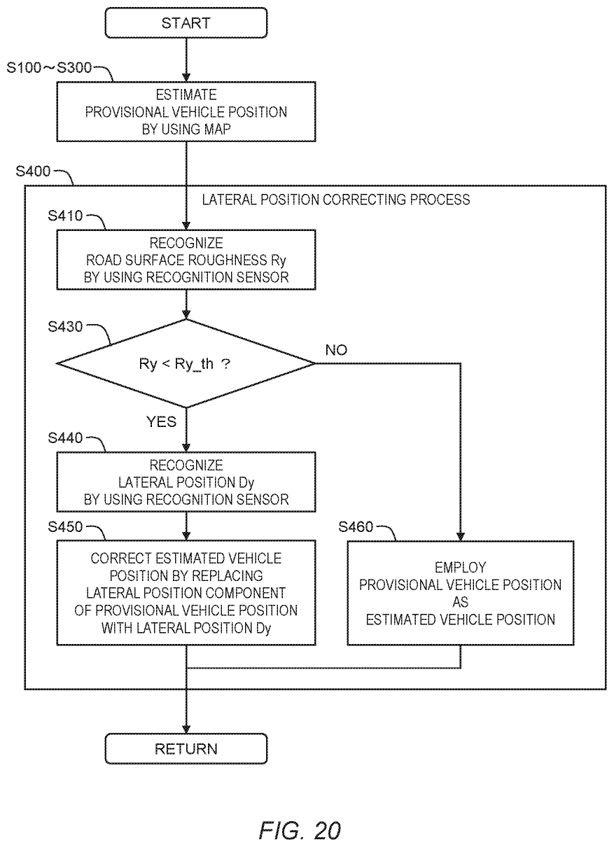

FIG. 20 is a flow chart showing another example of the lateral position correcting process. The control device 70 performs Step S440 between Step S430 and Step S450 instead of performing Step S420 prior to Step S430. The content of Step S440 is the same as Step S420. That is, only when the road surface roughness Ry is less than the threshold value Ry_th (Step S430; Yes), the control device 70 calculates the lateral position Dy.

It should be noted that, as shown in FIG. 18, the road surface roughness Ry recognized by the recognition sensor 30 is typically the road surface roughness Ry at the position Xa ahead of the vehicle 1. The position Xa does not coincide with the provisional vehicle position. However, since a road surface structure such as a rut (track) extends in the X-direction, the road surface roughness Ry can be assumed to continue for a certain distance in the X-direction. Therefore, in Step S430, the road surface roughness Ry at the position Xa can be compared with the threshold Ry_th. As a modification example, alignment of the position Xa and the provisional vehicle position may be performed. That is, the road surface roughness Ry at the current provisional vehicle position may be acquired from time-series data of the road surface roughness Ry acquired in the past, and then the road surface roughness Ry at the provisional vehicle position may be compared with the threshold Ry_th.

As another modification example, when a rut (track) on the road surface RS is detected by the recognition sensor 30 in Step S410, the road surface roughness Ry may be automatically set to a value equal to or greater than the threshold Ry_th. In other words, when a rut (track) on the road surface RS is detected by the recognition sensor 30, the road surface roughness Ry may be regarded to be equal to or greater than the threshold Ry_th (Step S430; No).

The lateral position correcting process described above makes it possible to improve the estimation accuracy of the vehicle position even when there is little road surface unevenness in the lateral direction.

### 5-7. Seventh Example for Improving Estimation Accuracy

It is also possible to combine two or more of the first to sixth examples described above as long as it does not cause contradiction. The combination makes it possible to further improve the estimation accuracy of the vehicle position.

### 5-8. Effects

As described above, according to the present embodiment, the accuracy of the localization utilizing the unsprung displacement map 200 is improved. That is, the estimation accuracy of the vehicle position is improved.

For example, it is possible to estimate the vehicle position with high accuracy even in an area that cannot be covered by the GNSS (e.g. a tunnel) or in an area where the accuracy of position estimation by the GNSS is low. Moreover, the method according to the present embodiment can be a substitute for the expensive GNSS.

The vehicle position (the position information 94) estimated by the localization according to the present embodiment is utilized in a variety of vehicle control. For example, the vehicle position is utilized for driving assistance control that assists driving of the vehicle 1. Examples of the driving assistance control include lane keeping control, collision avoidance control, automated driving control, and the like. In addition, the vehicle position is utilized for the preview control described above (see FIGS. 12 and 13). Since the estimation accuracy of the vehicle position is improved, the accuracy of the vehicle control utilizing the vehicle position is also improved.

### 6. Map Updating Process

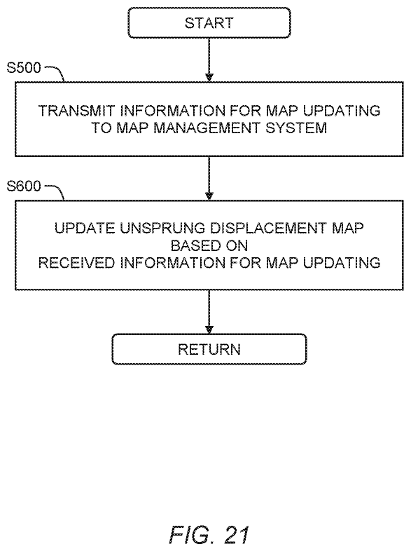

FIG. 21 is a flow chart showing a map updating process according to the present embodiment.

In Step S500, the control device 70 of the vehicle control system 10 transmits information for map updating to the map management system 100 via the communication device 50. The information for map updating includes time-series data of the position information 94 indicating the vehicle position acquired by the localization described in Section 5. In addition, the information for map updating includes time-series data of the sensor-based information (e.g., the sprung displacement Zs, the stroke H) necessary for calculating the unsprung displacement Zu. Alternatively, the information for map updating may include time-series data of the unsprung displacement Zu calculated by the control device 70. Moreover, the information for map updating may include time-series data of the vehicle speed V. Furthermore, the information for map updating may include information indicating a content of the localization. For example, the content of the localization includes whether or not the estimated vehicle position has been corrected based on the lateral position Dy, that is, which one of Step S450 and Step S460 has been performed.

In Step S600, the processor 120 of the map management system 100 receives the information for map updating via the communication device 110. The processor 120 updates the unsprung displacement map 200 based on the received information for map updating.

In some cases, high-accuracy position information is already registered as the position information in the unsprung displacement map 200. In that case, the processor 120 updates the position information in the unsprung displacement map 200 by combining the registered high-accuracy position information with the position information 94 included in the information for map updating. At this time, a weight for the position information 94 included in the information for map updating may be set to be smaller. For example, when a weight for the registered high-accuracy position information is 1, the weight for the position information 94 included in the information for map updating is set to 0.5.

When the correction of the estimated vehicle position is performed based on the lateral position Dy (Step S450), the position estimation accuracy may be lower as compared with the case where no correction is performed (Step S460). Therefore, the weight for the position information 94 when Step S450 is performed may be set to be smaller than the weight when Step S460 is performed.

As another example, only the unsprung displacement map 200 of an area where the high-accuracy position information is not yet registered may be updated.

What is claimed is:

1. A vehicle position estimation method comprising:
acquiring time-series data of a parameter related to a vertical motion of a wheel of a vehicle while the vehicle is traveling;
acquiring the parameter around the vehicle, as a reference parameter, from a parameter map indicating a correspondence relationship between the parameter and a position;
estimating a vehicle position of the vehicle based on a comparison between the time-series data of the parameter and time-series data of the reference parameter;
recognizing road surface roughness representing roughness of a road surface around the vehicle in a lateral direction by using a recognition sensor installed on the vehicle;
recognizing a lateral position of the vehicle in a road by using the recognition sensor; and
when the road surface roughness is less than a threshold, replacing a component of the lateral position of the estimated vehicle position with the lateral position recognized by using the recognition sensor.

2. The vehicle position estimation method according to claim 1, further comprising:
employing the estimated vehicle position, when the road surface roughness is equal to or greater than the threshold.

3. The vehicle position estimation method according to claim 1, wherein
the recognizing the road surface roughness includes:
using the recognition sensor to measure road surface displacements around the vehicle; and
calculating the road surface roughness based on a variance of the road surface displacements in the lateral direction.

4. The vehicle position estimation method according to claim 1, wherein
the estimating the vehicle position includes:
setting a plurality of imaginary trajectories of the wheel around the vehicle;
acquiring the time-series data of the reference parameter along each of the plurality of imaginary trajectories from the parameter map;
selecting, from the plurality of imaginary trajectories, one imaginary trajectory that yields a highest correlation between the time-series data of the parameter and the time-series data of the reference parameter; and
estimating the vehicle position based on a position of the selected one imaginary trajectory.

5. The vehicle position estimation method according to claim 1, wherein
the parameter is calculated based on sensor-based information obtained by a sensor installed on the vehicle,
the acquiring the time-series data of the parameter while the vehicle is traveling includes a first filtering process that applies a first filter to time-series data of the sensor-based information or the parameter, and
the parameter in the parameter map also is calculated through the first filtering process using the first filter.

6. The vehicle position estimation method according to claim 1, wherein
the parameter is calculated based on sensor-based information obtained by a sensor installed on the vehicle,
the acquiring the time-series data of the parameter while the vehicle is traveling includes a first filtering process that applies a first filter to time-series data of the sensor-based information or the parameter,
the parameter in the parameter map is calculated by applying a zero-phase filter to time-series data of the sensor-based information or the parameter,
the acquiring the reference parameter includes performing the first filtering process with respect to the time-series data of the reference parameter acquired from the parameter map; and
the estimating the vehicle position uses the time-series data of the reference parameter after the first filtering process.

7. The vehicle position estimation method according to claim 1, wherein
the parameter map indicates a correspondence relationship between the parameter, the position, and a vehicle speed, and
the acquiring the reference parameter includes acquiring the reference parameter according to the vehicle speed of the vehicle from the parameter map.

8. The vehicle position estimation method according to claim 7, wherein
the parameter map indicates the correspondence relationship between the parameter and the position for each vehicle speed range, and
the acquiring the reference parameter includes:
selecting the parameter map for the vehicle speed range to which the vehicle speed of the vehicle belongs; and
acquiring the reference parameter from the selected parameter map.

9. The vehicle position estimation method according to claim 1, wherein
an effective frequency range of the parameter is inversely proportional to a vehicle speed, and
the estimating the vehicle position includes making the comparison between the time-series data of the parameter and the time-series data of the reference parameter in a common effective frequency range in which the effective frequency range of the parameter and the effective frequency range of the reference parameter overlap each other.

10. A vehicle position estimation method comprising:
acquiring time-series data of a parameter related to a vertical motion of a wheel of a vehicle while the vehicle is traveling;
acquiring the parameter around the vehicle, as a reference parameter, from a parameter map indicating a correspondence relationship between the parameter and a position; and
estimating a vehicle position of the vehicle based on a comparison between the time-series data of the parameter and time-series data of the reference parameter, wherein
the parameter is calculated based on sensor-based information obtained by a sensor installed on the vehicle,
the acquiring the time-series data of the parameter while the vehicle is traveling includes a first filtering process that applies a first filter to time-series data of the sensor-based information or the parameter, and
the parameter in the parameter map also is calculated through the first filtering process using the first filter.

11. A vehicle position estimation method comprising:
acquiring time-series data of a parameter related to a vertical motion of a wheel of a vehicle while the vehicle is traveling;
acquiring the parameter around the vehicle, as a reference parameter, from a parameter map indicating a correspondence relationship between the parameter and a position; and
estimating a vehicle position of the vehicle based on a comparison between the time-series data of the parameter and time-series data of the reference parameter, wherein
the parameter map indicates a correspondence relationship between the parameter, the position, and a vehicle speed, and
the acquiring the reference parameter includes acquiring the reference parameter according to the vehicle speed of the vehicle from the parameter map.
